(19) United States
(12) Patent Application Publication
(10) Pub. No.: US 2009/0138133 A1
(43) Pub. Date: May 28, 2009

(54) POWER MANAGEMENT IN WAGERING GAME MACHINES

(75) Inventors: Dale R. Buchholz, Palatine, IL (US); Mark B. Gagner, West Chicago, IL (US); Robert A. Grom, Lake Zurich, IL (US); Steven J. Lee, Naperville, IL (US); Nevin J. Liber, Libertyville, IL (US); Craig J. Sylla, Round Lake, IL (US); Matthew R. Fitzdimons, Lake in the Hills, IL (US); Eric Ryan, Crest Hill, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/160,192

(22) PCT Filed: Jul. 21, 2006
(86) PCT No.: PCT/US06/28433

§ 371 Date: Jul. 7, 2008

Related U.S. Application Data
(60) Provisional application No. 60/743,099, filed on Jan. 6, 2006.

(51) Int. Cl. G05D 99/00; G06F 17/00

(52) U.S. Cl. 700/295; 463/16

(57) ABSTRACT

Systems and methods provide power management on a wagering game machine. Power consumption for various components of a wagering game machine may be adjusted based on various factors, including inactivity, component activity, power source changes, time based events, wireless access point proximity, change in battery voltage, credit level threshold, change in ambient lighting, related or adjacent machine power status, mode transition to play mode, mode transition to attract mode and mode transition to diagnostic mode. Power management events and power usage data may be communicated to a remote system for analysis or action. Power management commands or policies may be received from a remote system.

### RELATED APPLICATIONS

This application claims the priority benefit of U.S. Provisional Application Ser. No. 60/743,099 filed Jan. 6, 2006, the contents of which are incorporated herein by reference.

### FIELD

The embodiments relate generally to wagering game machines and more particularly to power management in wagering game machines.

### COPYRIGHT

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, 2006, WMS Gaming, Inc.

### BACKGROUND

Wagering games are very popular in many parts of the world. A gaming establishment may operate hundreds, thousands or ten of thousands of wagering game machines. Each of these gaming machines and their associated peripherals consume power and generate heat. As a result, operating costs associated with providing power to wagering game machines can be high.

Additionally, some jurisdictions are moving towards allowing portable wagering game device to be used within a gaming establishment. A portable wagering game device is typically powered by a battery. However, batteries provide only a limited amount of power. As a result, a portable gaming device may stop operating due to low battery power, leading to lost revenues for the gaming establishment.

### BRIEF DESCRIPTION OF THE DRAWINGS

FIG. 1A is a perspective view of a wagering game machine according to an example embodiment.

FIG. 1B is a perspective view of a portable wagering game machine according to an example embodiment.

FIG. 2A is a block diagram of processing components of a wagering game machine according to an example embodiment.

FIG. 2B is a block diagram of processing components of a portable wagering game machine according to an example embodiment.

FIG. 3 is a block diagram of software components of a wagering game machine according to an example embodiment.

FIG. 4 is a flowchart illustrating methods for managing power on a wagering game machine according to example embodiments.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The description of the various embodiments is to be construed as exemplary only and does not describe every possible instance of the invention. Numerous alternatives could be implemented, using combinations of current or future technologies, which would still fall within the scope of the claims. The following detailed description is, therefore, not to be taken in a limiting sense, and the scope of the present invention is defined only by the appended claims.

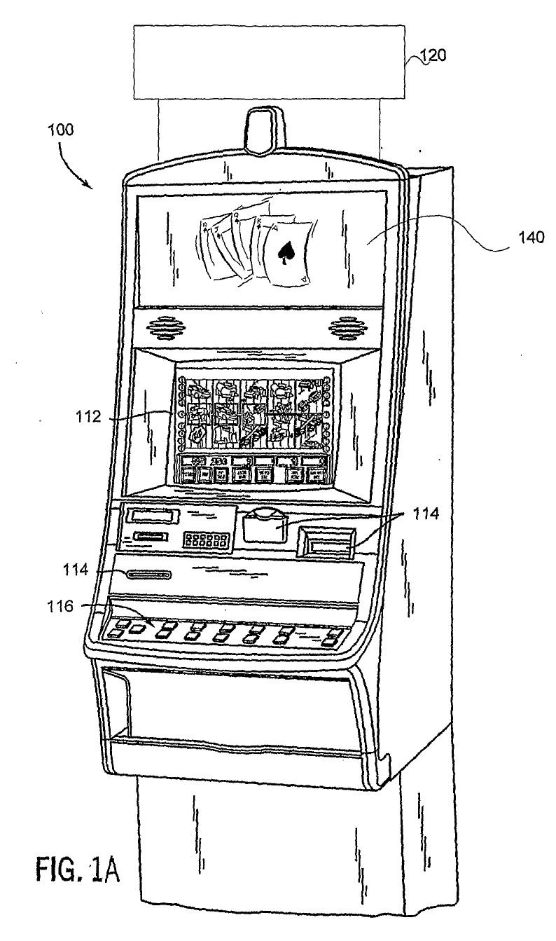

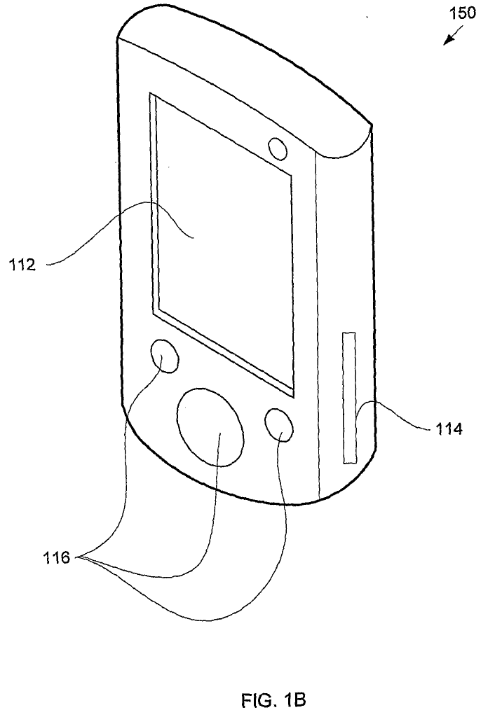

FIG. 1A illustrates an example wagering game machine 100 in which may be included various embodiments of the invention. In some embodiments, wagering game machine 100 is operable to conduct a wagering game. These wagering games may include reel based wagering games such as mechanical or video slots, card based games such as video poker, or other types of wagering games such as video keno, video bingo or a video dice game. If based in video, the wagering game machine 100 includes a video display 112 such as a cathode ray tube (CRT), liquid crystal display (LCD), plasma, or other type of video display known in the art. In the illustrated embodiment, the wagering game machine 100 is an “upright” version in which the display 112 is oriented vertically relative to a player. Alternatively, the wagering game machine may be a “slant-top” version in which the display 112 is slanted at about a thirty-degree angle toward the player. Further, the wagering game machine may be a “bar-top” version in which the display is mounted horizontally in a bar top or table top. Still further, the wagering game machine may be housed in a wall mounted or other vertically mounted cabinet.

The wagering game machine 100 may include a plurality of possible credit receiving mechanisms 114 for receiving credits to be used for placing wagers in the game. The credit receiving mechanisms 114 may, for example, include a coin acceptor, a bill acceptor, a ticket reader, and a card reader. The bill acceptor and the ticket reader may be combined into a single unit. The card reader may, for example, accept magnetic cards and smart (chip) cards coded with money or designating an account containing money.

In some embodiments, the wagering game machine 100 includes a user interface comprising a plurality of push-buttons 116, and other possible devices. The plurality of push-buttons 116 may, for example, include one or more “bet” buttons for wagering, a “play” button for commencing play, a “collect” button for cashing out, a help” button for viewing a help screen, a “pay table” button for viewing the pay table(s), and a “call attendant” button for calling an attendant. Additional game specific buttons may be provided to facilitate play of the specific game executed on the machine. A touch screen overlaying video display 112 may define touch keys for implementing many of the same functions as the push-buttons. Additionally, in the case of video poker, the touch screen may implement a card identification function to indicate which cards a player desires to keep for the next round. Other possible user interface devices include a keyboard and a pointing device such as a mouse or trackball.

In some embodiments, wagering game machine 100 includes a top box 140. Top box 140 may contain a video display, a mechanical display, or a diorama display that supplements display 112. For example, the display in top box 140 may be a wheel such as a rotating wheel, mechanical dice, a board for a board game, or other such display.

A processor controls operation of the wagering game machine 100. In response to receiving a wager and a command to initiate play, the processor randomly selects a game outcome from a plurality of possible outcomes and causes the display 112 to depict indicia representative of the selected game outcome. In the case of slots for example mechanical or simulated slot reels are rotated and stopped to place symbols on the reels in visual association with one or more pay lines. If the selected outcome is one of the winning outcomes defined by a pay table, the CPU awards the player with a number of credits associated with the winning outcome.

In some embodiments, wagering game machine 100 may include signage 120. Signage 120 may be a display device capable of displaying advertising, gaming information (e.g. type of game, denomination of game etc.) or other information to a player or potential player.

FIG. 1B is a perspective view of a portable wagering game machine 150 according to an example embodiment. In these embodiments, the wagering game machine may be housed in a portable or handheld device. In such devices, the user interface elements (buttons 116, screen 112 etc.) may be scaled down in size or number in order to fit the elements into an appropriate housing for a handheld or portable wagering game machine. Screen 112 may be a touch sensitive screen that may provide an input mechanism for the portable wagering game machine. In some embodiments, a money/credit detector 114 may be a card reader designed to read and/or write a credit card or player tracking card linked to a credit account.

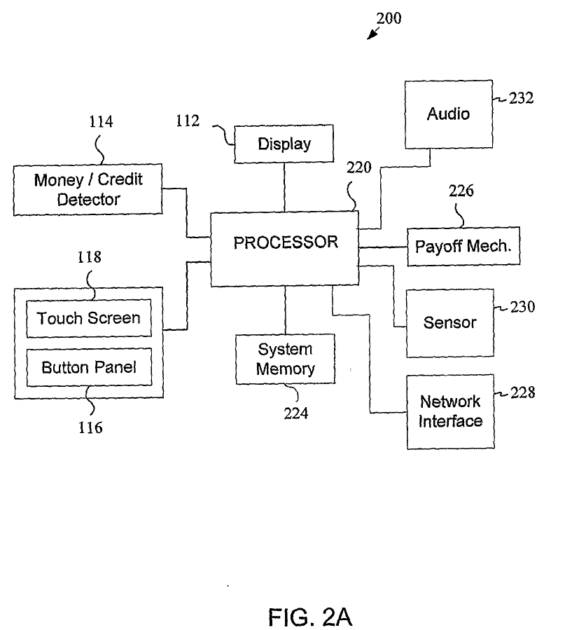

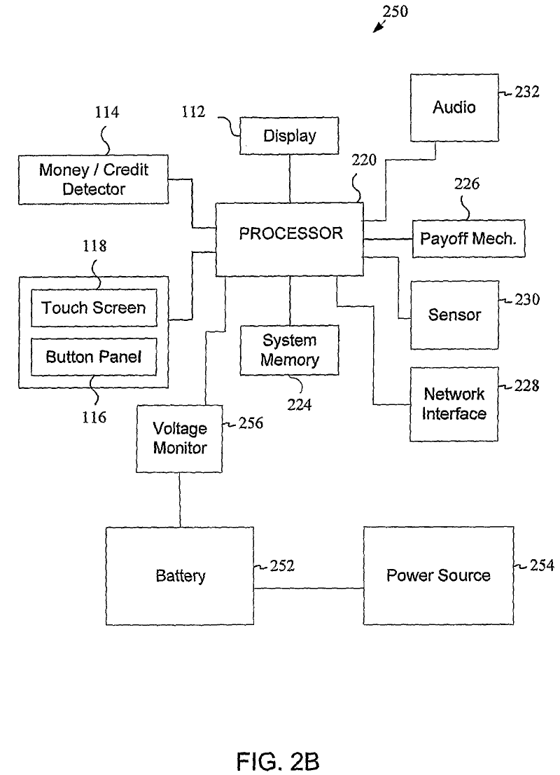

FIG. 2A is a block diagram of a control system 200 having various components suitable for operating the wagering game machine 100. Money/credit detector 222 signals a processor 220 when a player has inserted money, tickets, tokens, cards or other mechanism for obtaining credits for plays on the wagering game machine through credit mechanisms 114. Using a button panel 116 and/or a touch screen 218, the player may select any variables associated with the wagering game and place his/her wager to purchase a play of the game. In a play of the game, the processor 220 generates at least one random event using a random number generator (RNG) and provides an award to the player for a winning outcome of the random event. Alternatively, the random event may be generated by a remote computer using an RNG or pooling schema and then transmitted to the wagering game machine. The processor 220 operates the display 112 to represent the random event(s) and outcome(s) in a visual form that can be understood by the player. In addition to the processor 220, the control system may include one or more additional slave control units for operating the display 112 and any secondary displays.

System memory 224 stores control software, operational instructions and data associated with the wagering game machine. In some embodiments, the system memory 224 comprises a separate read-only memory (ROM) and battery-backed random-access memory (RAM). However, it will be appreciated that the system memory 224 may be implemented on any of several alternative types of memory structures or may be implemented on a single memory structure. For example, memory 224 may comprise multiple banks of volatile or non-volatile memory, including RAM, compact flash, hard drives, CD-ROM drives, DVD-ROM drives and combinations thereof. Additionally, some or all of memory 224 may comprise MRAM (magnetoresistive or magnetic RAM). Generally speaking, MRAM is a non-volatile RAM memory technology that uses magnetic charges to store data instead of electric charges. In further alternative embodiments, NVRAM 44 and 46 may be FRAM (Ferromagnetic RAM). MRAM and FRAM may be desirable, because they do not require power in order for the memory to retain data.

A payoff mechanism 226 is operable in response to instructions from the processor 220 to award a payoff to the player. The payoff may, for example, be in the form of a number of credits. The number of credits is determined by one or more math tables stored in the system memory 224. As noted above with respect to FIG. 1, the payoff mechanism may be a coin hopper, a ticket printer, a magnetic card writer, or a database update mechanism that updates a database maintaining account information.

Network interface 228 operates to communicably couple system 200 in wagering game machine 100 to a network. The network may be any type of wired or wireless network and the network interface 228 may vary based on the type of network. In some embodiments, the network comprises a gaming establishment network such as a LAN (local area network). In alternative embodiments, the network may be an intranet linking multiple networks, for example, the networks of a gaming enterprise that operates multiple gaming establishments. In further alternative embodiments, the network may comprise the Internet.

In some embodiments, one or more sensors 230 may be present on the control system. A sensor 230 may detect temperature conditions, lighting conditions, audio, motion or other environmental qualities regarding the wagering game machine. Additionally, sensor 230 may detect that a person is occupying a seat attached to or associated with the wagering game machine.

Some embodiments of the invention include an audio subsystem 232. Audio subsystem 232 provides audio capabilities to the wagering game machine and may comprise an audio amplifier, speakers, and may further include an audio programming source on a memory such as a CD, DVD, flash memory etc.

FIG. 2B is a block diagram of processing components 250 of a portable wagering game machine according to an example embodiment. Portable wagering game machine processing components 250 include many of the same components having the same function as described above in FIG. 2A. In addition, portable wagering game processing components 250 may include a battery 252, a power source 254 and a voltage monitor 256. Battery 252 provides power when power source 254 is either unavailable or unable to provide sufficient power to the portable wagering game machine.

Power source 254 provides a source of power to charge battery 252 and/or to provide power to processing components 250. In some embodiments, power source 254 may be a power supply designed to convert AC power to DC power when connected to a line source. In alternative embodiments, power source 254 may be a solar cell. In further alternative embodiments, power source 254 may be an inductive power source that provides power that is transferred through magnetic induction from a second power source to the portable wagering machine when the portable wagering game machine is in proximity to the second power source. In still further alternative embodiments, power source 254 may be a generator that supplies power through kinetic energy, such as motion of the portable wagering game machine or a hand crank that, when turned, causes the generator to produce power that may be used to charge the battery or operate the portable wagering game machine.

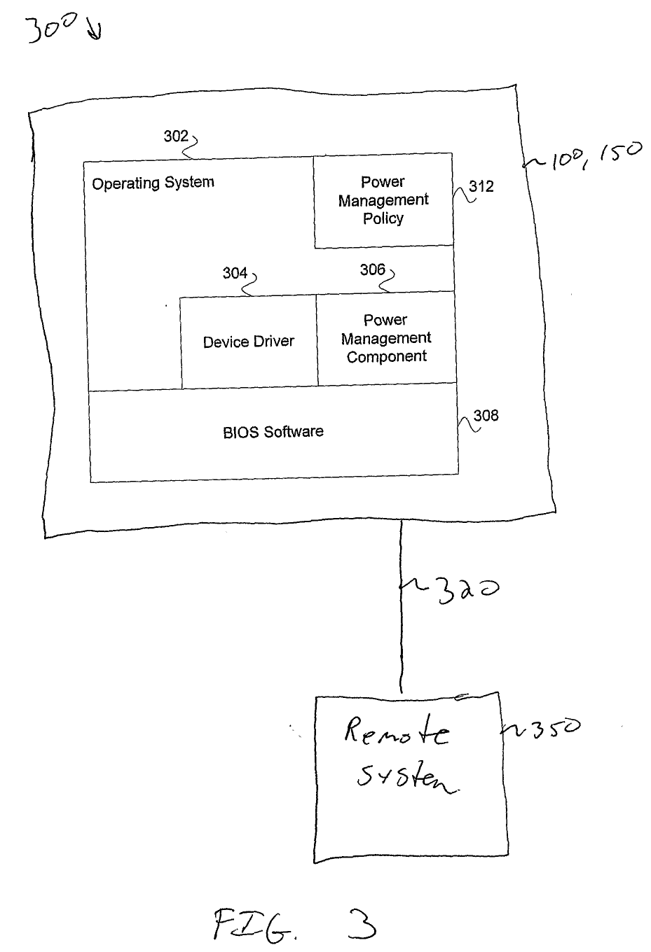

FIG. 3 is a block diagram of software components 300 of a wagering game system 200 or portable wagering game system 250 according to an example embodiment. In some embodiments, software components 300 include operating system 302, device driver 304, power management component 306 and BIOS (Basic Input/Output System) software 308. Operating system 302 manages the execution of programs and tasks running on processor 102, and manages devices such as hard drives, floppy drives, CD-ROM drives, DVD-ROM drives, ticket printers, button devices, video devices, network interfaces and other devices. In some embodiments of the invention, operating system 202 may be one of the Microsoft Windows family of operating systems available from Microsoft Corporation of Redmond, Wash. These operating systems include Windows 95®, Windows 98®, Windows CE®, Windows NT®, Windows 2000®, Windows ME® and Windows XP®. Additionally, operating system 302 may be a UNIX operating system or a UNIX like operating system such as Linux® or FreeBSD. Alternatively, operating system 302 may be the Mac OS® operating system from Apple Computer Incorporated, Cupertino, Calif. Further, operating system 302 maybe a real-time operating system such as VRTX or QNX. No embodiment of the invention is limited to a particular operating system.

Device driver 304 provides an interface between software such as operating system 302 and wagering game applications controlled by operating system 302, and hardware such as storage devices, video devices, ticket printer devices, coin hopper devices, credit detection devices, and other devices on a wagering game machine 100. Device driver 304 typically translates standard operating system video functions for operating system 302 into the specific commands required by the specific device and/or firmware resident on wagering game system 200 or portable wagering game system 250.

In some embodiments, a power management component 306 comprises software that interfaces with power management hardware and firmware on wagering game system 200 or portable wagering game system 250. Examples of such functions include functions that detect whether the computer system is currently connected to an AC power source, functions that obtain the current state of a battery used to provide power and functions that detect the level of charge in a battery. In some embodiments, power management component 306 may conform to an Advanced Power Management (APM) standard. APM is an API (Application Program Interface) developed by Intel and Microsoft which allows a BIOS 308 to perform power management, such as reducing the processor speed, turning off devices or turning off power to the display upon the occurrence of a power management event. In alternative embodiments, power management component may conform to ACPI (Advanced Configuration and Power Interface) specification first released in December 1996 and developed by HP, Intel, Microsoft, Phoenix and Toshiba. ACPI defines common interfaces for hardware recognition, system and device configuration and for power management. On aspect of ACPI is that it places the operating system 302 in control of power management. In ACPI, the BIOS 308 may be responsible for the details of communicating with hardware equipment under the control of operating system 302.

Another aspect of ACPI is that it provides power management features such as enabling low power consumption states (suspend, hibernate, sleep etc.), in which only memory, or not even memory is powered, but from which ordinary interrupts (real time clock, buttons, touch screen input, etc.) can quickly wake the system.

BIOS software 308 may reside in a separate memory from system memory 224 and comprises a set of functions that control basic aspects of hardware and hardware controllers that may be part of a wagering game system 200 or portable wagering game system 250. BIOS software 308 may also include functions related to power management, such as the functions described above with respect to power management component 306.

While some embodiments include BIOS software 308, not all embodiments need include or utilize BIOS software 308, and in alternative embodiments the driver layer software such as device driver 304 and power management component 306 interface directly with the hardware rather than through BIOS software 308.

Power management policies 312 comprise data defining a set of one or more policies that may specify actions that take place upon the occurrence of power management events. In some embodiments, the policies may be based on battery levels, inactivity time values, time of day/day of week/day of year parameters, scheduled downtime parameters, heat level parameters, or other operating characteristics associated with a wagering game machine 100 or portable wagering game machine 150. These polices may comprise default actions, or they may be customized by an administrator through a power management user interface. Further, the policies may be automatically learned from wagering game machine usage. For example, if a wagering game machine is consistently idle during certain times of the day, a power management policy may be automatically defined that places the wagering game machine in a lower power consumption state during the learned idle periods. Conversely, if wagering game usage indicates that the wagering game machine is consistently in use during a particular time of day, a power management policy may be automatically defined that disables reduced power consumption modes during the non-idle periods.

In some embodiments, system 300 may include a remote system 350. Remote system 350 may be a server, administrative workstation, or any other type of system communicably coupled to a wagering game machine 100 or portable wagering game machine 150 through a network 320. Network 320 may be a wireless network or a wired network. Additionally, network 320 may be a LAN, WAN or corporate intranet.

In some embodiments, a wagering game machine 100 or portable wagering game machine 150 may report or communicate power management events or power usage data to remote system 350. Remote system 350 may store and/or analyze the power management or power usage data. In some embodiments, the power management or power usage data may indicate that the wagering game machine 100 or portable wagering game machine 150 is in need of service. For example, a machine that is not drawing an anticipated amount of current may have a bulb that is burned out, indicating that the machine needs a bulb replacement. Alternatively, a machine that is drawing more than the anticipated amount of current may have a defective component that is about to fail or has failed.

In some embodiments, remote system 350 may communicate power management commands, events or policies 312 to a wagering game machine 100 or portable wagering game machine 150. For example, the power usage of a wagering game machine 100 or group of wagering game machines is considered too high, a remote system 350 may communicate a power management command or event instruction one or more wagering game machines to go to a lower power consumption mode. Additionally, new or modified policies may be communicated from a remote system 350 to one or more wagering game machines 100 or portable wagering game machines 150. For example, various time of day, or day of week power management policies may be updated based on anticipated machine usage and sent from remote system 350 to wagering game machines 100 or 150.

In some embodiments, remote system 350 may store power management events or power usage data received from wagering game machines to create a power usage history. The stored power usage history data may then be used for trend analysis and/or to detect if current power usage by a wagering game machine or machines is anomalous.

In further embodiments, power management events or power usage data maybe used by remote system 350 to adjust environmental conditions for a gaming establishment such as a casino. For example, power usage may be correlated with heat generation. Thus the power usage data may be used by a remote system to determine if adjustments in heating or cooling settings or capacity are desirable.

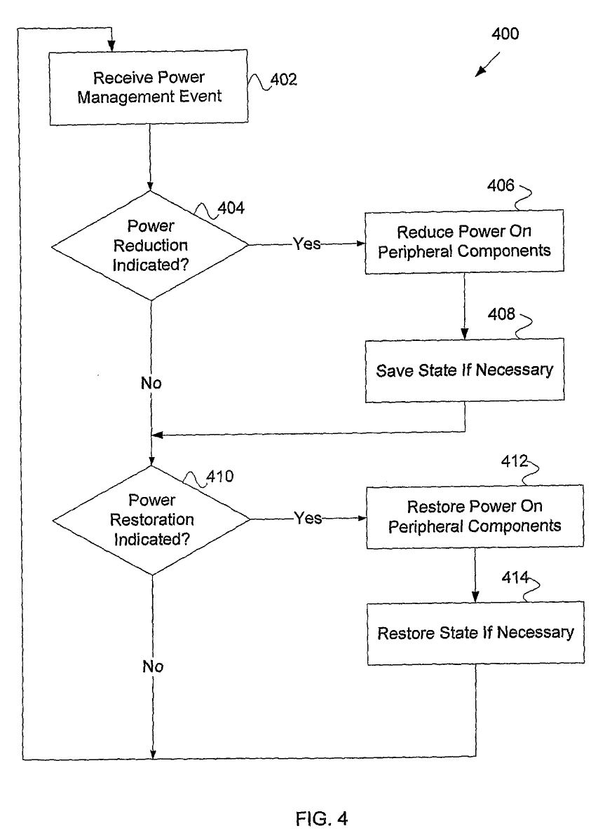

Further details on the operation of the system are provided below with reference to FIG. 4.

FIG. 4 is a flowchart illustrating methods for managing power on a wagering game machine according to example embodiments. The methods to be performed by the operating environment constitute computer programs made up of computer-executable instructions. Describing the methods by reference to a flowchart enables one skilled in the art to develop such programs including such instructions to carry out the method on suitable processors for wagering game machines (the processor or processors of the computer executing the instructions from computer-readable media). The methods illustrated in FIG. 4 are inclusive of acts that may be taken by an operating environment executing an exemplary embodiment of the invention.

In some embodiments, the method begins when a system executing the method receives a power management event (block 402). In some embodiments, the event may indicate that a change has been made in the wagering game environment that may warrant a change in the current power management state. Many types of events are possible. The following is a non-exclusive list of some of various power management events that may be included in various embodiments:
Inactivity In some embodiments, an inactivity timer indicating that the wagering game machine has not been in use may trigger power reduction activity.
Activity on a component—Pressing a button, touching the screen, inserting a card in a card reader receiving data over a network or phone line etc. may all cause power to be restore on previously idled components.
Power source change An event may indicate that the system is no longer connected to an AC power source or has been reconnected to an AC power source.
Change in proximity to wireless access point—a portable wagering game device may move about a gaming establishment, as the gaming device moves nearer or further from a wireless access point, the RF output may be adjusted downward or upward respectively.
Change in battery voltage—May result in power being reduced (e.g. lights dimmed, audio volume turned down or off, hard drive idled etc.) if battery voltage decreases past a threshold value.
Decrease in ambient lighting—Allows backlighting to be reduced for most displays types, causes increase in power requirements for transreflective displays.
Increase in ambient lighting—Allows backlighting to be reduced for transreflective displays, increases backlighting for most display technologies.
Credit level—If a sufficient number of credits are already available, the credit detection devices such as card readers or ticket readers may be powered down on the assumption that they are not necessary until the credit level has decreased to a point where more credit may need to be purchased.
Door open—Lower power to wagering game components because it unlikely that a player is using the wagering game machine when a door or cover on the wagering game machine is open.
Transition to play mode—Lower power to diagnostic equipment in the wagering game machine that is not used when the wagering game is in its normal play mode.
Transition to Attract Mode—Lower power to input devices such as touch screen, button panel, card reader, ticket reader etc., and increase power to output devices such as displays and audio devices as the wagering game machine is attempting to attract users.
Transition From Attract Mode to Play Mode—Increase/apply power to input devices such as touch screen, button panel, card reader, ticket reader etc., because the devices may be used during wagering game play, and reduce power to output devices such as displays and audio devices as the wagering game machine no longer needs to attract a player.
Motion detection—restore power when a portable wagering game machine is moved.
Proximity detection—restore power when a player occupies a chair associated with the wagering game machine.
Change In Power Status Of Related/Adjacent Wagering Game Machine—Power reduction or restoration events on one or more related or adjacent wagering game machines may be replicated on a current wagering game machine. For example, if an adjacent wagering game machine experiences a power restoration event due to a proximity detection, the current wagering game machine may also have power restored.

The system then checks to see if the event is a power reduction event (block 404). Various types of power reduction events are possible as detailed above. If the event is a power reduction event, then the system proceeds to reduce power or eliminate power to one or more of the components of the wagering game system (block 406). Examples of such power reduction include turning off a display, top box animation, or signage associated with a wagering game machine, turning off a ticket printer, turning of a coin hopper, turning off a bill acceptor, coin acceptor or other credit reader, turning off or reducing backlighting for displays, turning off or dimming button lights etc. Further, power to a processor may be reduced by reducing the speed of the processor, or turning off power to the processor.

In some embodiments, the system saves the current state of the wagering game machine or the state of a wagering game application executing on the wagering game machine (block 408). This may include completing any wagering transactions that were in process. In alternative embodiments, the system may check the battery level before every transaction to ensure there is enough power to complete the transaction. This is desirable, because certain power management events, such as low battery level events, may cause the wagering game machine to shut down entirely. In some embodiments, the power reduction event may result in wagering games being completed and temporarily disabled, but other non-wagering applications such as entertainment games, video entertainment applications, email, and other such non-wagering applications may continue or be started.

A check is also made to determine if the power management event is a power restoration event (block 410). Various types and combinations of power restoration events are possible as listed above. If the event is a power restoration event, power may be restored or power requirements increased for one or more wagering game system components. For example, the power management event may result in increasing backlighting, turning on a coin hopper, turning on a bill or coin acceptor, turning on displays, top box animations, or lighting on the wagering game machine, increasing processor speed etc.

Next, the system checks to see if any wagering game machine state needs to be restored, and if so, proceeds to restore a saved state (block 414). As noted above, if power is reduced to the point where the wagering game machine may not function properly, the system saves the current state of the machine (see block 408). Upon restoration of power, the saved state may be restored. This is desirable, because it may lead to decreased time for a wagering game machine to become operational when compared to rebooting the wagering game machine.

Additionally, in some embodiments, the system checks to see if the wagering game machine's configuration has changed when a power restoration event occurs. This is desirable, because a user or technician may have installed, removed, or otherwise changed a peripheral component of the wagering game machine.

It should be noted that some events may result in both power restoration and power reduction. For example, as noted above, transitions between attract mode and play mode may result in power being restored to some devices while power is reduced to other devices.

### CONCLUSION

Systems and methods for managing power on a wagering game machine have been described. Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the inventive subject matter.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that the inventive subject matter be limited only by the following claims and equivalents thereof.

The Abstract is provided to comply with 37 C.F.R. § 1.72(b) to allow the reader to quickly ascertain the nature and gist of the technical disclosure. The Abstract is submitted with the understanding that it will not be used to limit the scope of the claims.

1. A method comprising:
receiving a wager for a wagering game on a wagering game machine;
detecting a power management event in the wagering game machine; and
adjusting power consumption for at least one wagering game machine component.

2. The method of claim 1, wherein the power management event is selected from the group consisting of: inactivity timeout, component activity, power source change, time based event, wireless access point proximity, change in battery voltage, credit level threshold, change in ambient lighting, related or adjacent machine power status, mode transition to play mode, mode transition to attract mode and mode transition to diagnostic mode.

3. The method of claim 1, further comprising saving the state of a wagering game machine component upon receipt of a power reduction event.

4. The method of claim 1, further comprising restoring the state of a wagering game machine component upon receipt of a power restoration event.

5. The method of claim 1, further comprising determining if a configuration of the wagering game machine has changed upon receiving a power restoration event.

6. The method of claim 1, wherein the wagering game machine includes a plurality of wagering game machine components, and further comprising:
increasing power consumption for a first subset of the wagering game machine components; and
decreasing power consumption for a second subset of wagering game machine components.

7. The method of claim 1, further comprising communicating the power management event to a remote system.

8. The method of claim 1, further comprising communicating power usage data to a remote system.

9. The method of claim 1, further comprising receiving a power management policy from a remote system.

10. The method of claim 7, wherein the wagering game machines adjusts power in response to a command received from the remote system.

11. An apparatus comprising:
a wagering game machine including a processor and a memory;
a wagering game application executable by the processor and operable to receive a wager; and
a power management component executable by the processor and operable to:
detect a power management event; and
adjust power consumption for at least one component on the wagering game machine.

12. The apparatus of claim 11, wherein the power management component comprises an ACPI power management component.

13. The apparatus of claim 11, wherein the memory comprises ferromagnetic memory.

14. The apparatus of claim 11, wherein the wagering game machine is a portable wagering game machine, and further comprising:
a battery; and
a power source operable to charge the battery.

15. The apparatus of claim 14, wherein the power source is selected from the group consisting of AC power supply, DC power supply, crank generator, solar cell or inductive power source.

16. The apparatus of claim 11, further comprising a sensor and wherein a value from the sensor causes the power management event.

17. The apparatus of claim 16, wherein the sensor is selected from the group consisting of: motion sensor, ambient lighting sensor, audio sensor or heat sensor.

18. A computer-readable medium having computer executable instructions for causing a processor to:
receive a wager for a wagering game on a wagering game machine;
detect a power management event in the wagering game machine; and
adjust power consumption for at least one wagering game machine component.

19. The computer-readable medium of claim 18, wherein the power management event is selected from the group consisting of: inactivity timeout, component activity, power source change, time based event, wireless access point proximity, change in battery voltage, credit level threshold, change in ambient lighting, related or adjacent machine power status, mode transition to play mode, mode transition to attract mode, and mode transition to diagnostic mode.

20. The computer-readable medium of claim 18, further comprising computer executable instructions to cause the processor to save the state of a wagering game machine component upon receipt of a power reduction event.

21. The computer-readable medium of claim 18, further comprising computer executable instructions to cause the processor to restore the state of a wagering game machine component upon receipt of a power restoration event.

22. The computer-readable medium of claim 18, further comprising computer executable instructions to cause the processor to determine if a configuration of the wagering game machine has changed upon receiving a power restoration event.

23. The computer-readable medium of claim 18, further comprising computer executable instructions to cause the processor to:
increase power consumption for a first subset of wagering game machine components; and
decrease power consumption for a second subset of wagering game machine components.
